(19) United States
(12) Patent Application Publication
(10) Pub. No.: US 2023/0075470 A1
(43) Pub. Date: Mar. 9, 2023

(54) CATALYST CARRIER STRUCTURE

(71) Applicant: YUAN FANG APPLIED MATERIALS CO., LTD, Zhubei City (TW)

(72) Inventor: WEN-CHENG CHIEN, Hsinchu City (TW)

(73) Assignee: YUAN FANG APPLIED MATERIALS CO., LTD, Zhubei City (TW)

(21) Appl. No.: 17/888,995

(22) Filed: Aug. 16, 2022

(30) Foreign Application Priority Data
Sep. 9, 2021 (TW) 110133550

(51) Int. Cl. B01J 35/06; B01J 35/02; B01J 21/18; B01J 31/06

(52) U.S. Cl. CPC B01J 35/06; B01J 35/023; B01J 21/18; B01J 31/06

(57) ABSTRACT

The catalyst carrier structure of the present invention includes a central axis, and a plurality of fibers. The surface of each fiber is coated with a catalyst. The fibers are centered on the central axis, and are arranged around the central axis radially outward along the axial direction of the central axis. Each fiber is an independent and separate fiber set on the central axis.

### BACKGROUND OF THE INVENTION

### 1. Field of the Invention

The present invention is related to catalyst carrier technology, particularly refers to a divergent catalyst carrier structure.

### 2. Description of the Related Art

At present, there are many disinfection and sterilization equipment on the market that use catalysts, such as photocatalysts, as the main mechanism for disinfection and sterilization. To be able to use photocatalyst for disinfection and sterilization, two conditions must be met at the same time. First of all, there must be a photocatalyst carrier, so that the photocatalyst can be attached to the carrier, and the carrier must have a large enough surface area to be in contact with the air. The larger the surface area in contact, the larger the range in which the reaction can be carried out. The second is to have light. Through the irradiation of light, the photocatalyst can carry out chemical reaction. The more photocatalyst is irradiated by light, the more photocatalyst will react.

Judging from the existing commercially available products, most of the methods are to coat the photocatalyst on a breathable filter, and then set a light source to illuminate the filter. However, most of the filters are flat, so the contact area of the filter with air and light at the same time is mostly limited to one plane or two front and back planes. After all, such a reaction area is not enough, so it is necessary to set up multiple or multi-layer filters and light sources to increase the contact area between air or light and the photocatalyst.

Therefore, how to greatly increase the contact area of photocatalyst with air and increase the area of photocatalyst irradiated by light in a limited space has become a problem that must be improved.

### SUMMARY OF THE INVENTION

The present invention has been accomplished under the circumstance in view. It is therefore the main object of the present invention to provide a catalyst carrier structure, which utilizes a special structural design to greatly increase the contact area between the catalyst and the air in a limited space, so as to improve the reaction efficiency of the sterilization equipment.

To achieve this and other objects of the present invention, the catalyst carrier structure of the present inventio comprises a central axis, and a plurality of fibers centered on the central axis and arranged around the central axis radially outward along the axial direction of the central axis. The fibers are independent and separate fibers, so that the three-dimensional dispersion of these fibers fills a space. The surface of each fiber is coated with a catalyst.

As can be seen from the above, the catalyst carrier structure of the present invention can make these fibers three-dimensionally and dispersedly dispersed in a space. The gap formed between the fibers can be used for air circulation or light to pass through, so as to greatly increase the contact area between the catalyst and the air in a limited space, so as to improve the reaction efficiency of the sterilization equipment.

Preferably, the diameter of the fibers is about 10 μm to 50 μm.

Preferably, the length of the fibers is 1˜200 mm.

Preferably, the fibers are selectively made of carbon fiber, glass fiber, or polyester.

The detailed structure, characteristics, assembly or use mode provided by the present invention will be described in the detailed description of the subsequent implementation mode. However, those with ordinary knowledge in the field of the present invention should be able to understand that the detailed description and the specific embodiments listed in the implementation of the present invention are only used to illustrate the present invention, and are not intended to limit the scope of the patent application of the present invention.

### BRIEF DESCRIPTION OF THE DRAWINGS

FIG. 1 is a schematic elevational of the first embodiment of the present invention

FIG. 2 is a top view of the first embodiment of the present invention.

FIG. 3 is a sectional view of the first embodiment of the present invention.

FIG. 4 is a schematic applied view of the first embodiment of the present invention.

FIG. 5 is a top view of the second embodiment of the present invention.

FIG. 6 is a sectional view of the second embodiment of the present invention.

FIG. 7 is a schematic applied view of the second embodiment of the present invention.

### DETAILED DESCRIPTION OF THE INVENTION

The applicant first explains here that in this specification, including the embodiments described below and the claims of the scope of patent application, the nouns related to directionality are based on the direction in the diagram. Secondly, in the embodiments and drawings that will be introduced below, the same element numbers represent the same or similar elements or their structural features.

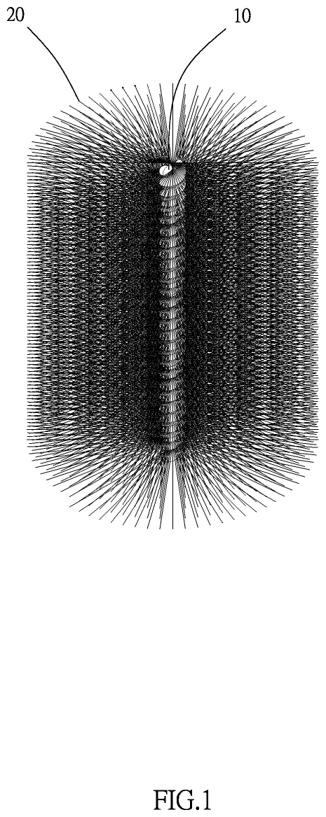

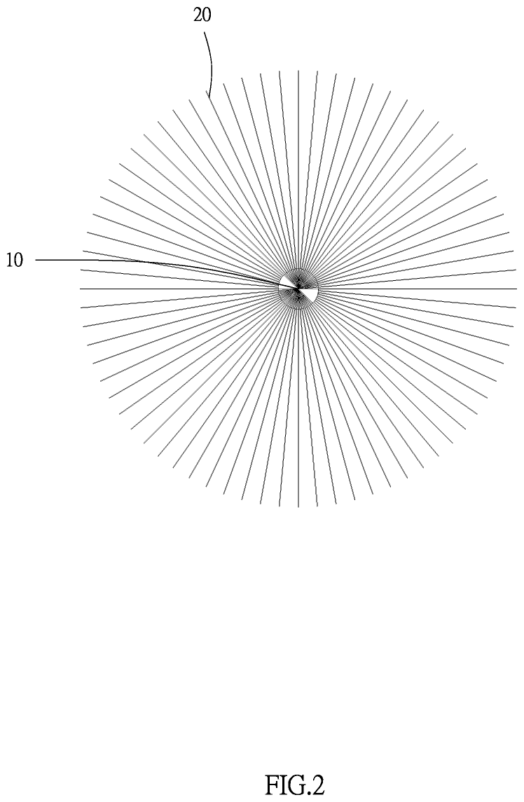

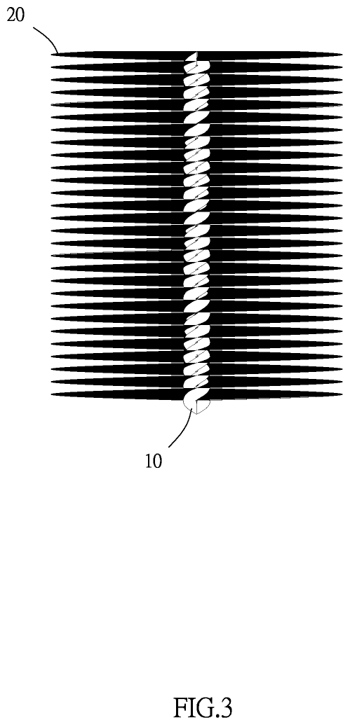

Please refer to FIGS. 1-4 first, the catalyst carrier structure of the first embodiment of the present invention comprises a central axis 10 and a plurality of fibers 20.

The central axis 10 can be a solid structure or a virtual imaginary central axis. In this embodiment, it is a solid columnar structure.

The surface of each fiber 20 is coated with a catalyst. The fibers 20 are centered on the central axis 10, and are arranged around the central axis 10 radially outward along the axial direction of the central axis 10. The fibers 20 are independent and separate fibers arranged on the central axis 10. These fibers can be in the form of straight strips or spirals, etc. These fibers 20 can be made of carbon fiber, glass fiber, or polyester. The diameter of each fiber is about 10 μm-50 μm, and its length is 1˜200 mm. If the diameter of the fibers 20 is too small, it may not be able to support the weight of the fibers themselves and sag, If the diameter of fibers 20 is too large, it will take up too much space, increase the overlap between fibers in the space, reduce the circulation of light and air, and lose the function of three-dimensional dispersion. The length of the fibers themselves should not be too long, because too long fibers cannot support their own weight and will sag. Sagging will increase the overlap or shading between the fibers, so it is impossible to form a radial three-dimensional dispersion when setting.

The catalyst mentioned in this case can be nano-silver catalyst or photocatalyst, or a catalyst containing three precious metals of platinum, palladium and rhodium, or tin-iron oxide, etc. Tin-iron oxide is a postdoctoral researcher in the Laboratory of Nanomaterials and Nanostructures led by Professor Lu Shiyuan of Tsinghua University. Li Guanting researches the application of “tin-iron oxide (SnFe2O4)”. It was found to rapidly decompose organic matter in sewage (the third fastest degradation rate known in the literature). The paper was published in the international academic journal “Journal of Material Chemistry A” in May 2019. In this example, a photocatalyst is used as an illustrative example, but it is not limited to this.

In the first embodiment of the present invention, the central axis 10 is a helical central axis. Therefore, when the fibers 20 are arranged on the central axis 10, they also exhibit a helical distribution along with the helical rotation of the central axis 10. Of course, the central axis is not limited to a spiral shape, but can also be a straight column. The distribution of these fibers 20 is not limited to a spiral shape, but can also be a hierarchical arrangement. That is, at the position of the same layer, with the central axis as the center, complex fibers are arranged in radial radiation, and multiple layers are continuously arranged from one end of the central axis 10 to the other end. Or these fibers can also be centered on the central axis 10, radial radiation is set but not layered, and there is no high-low top-bottom order setting.

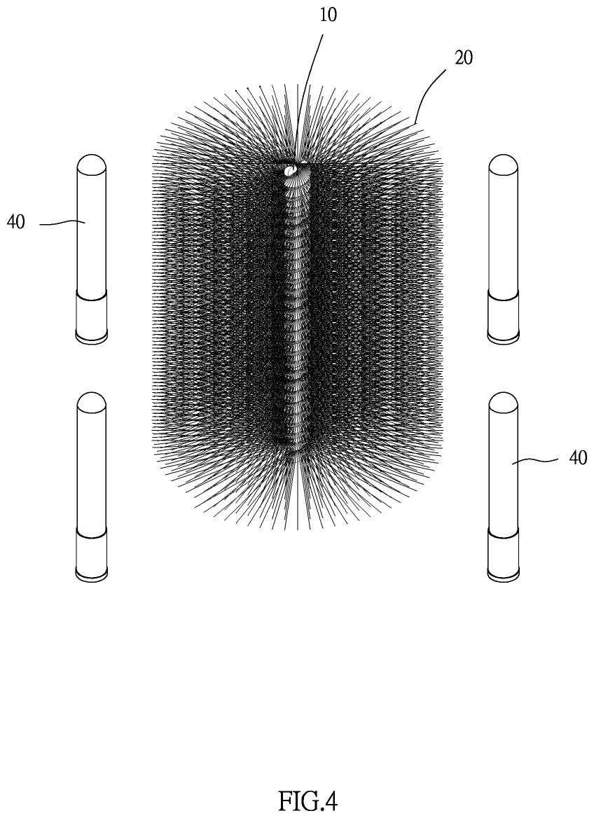

With the structure of the first embodiment of the present invention, the fibers 20 can be dispersed and filled in a space, as shown in FIG. 4, if the catalyst used is a photocatalyst, the light generated by the light sources 40 provided in the space can be irradiated to various positions of the fibers 20. Moreover, because each fiber 20 is in the form of radial divergence in space, the overlap portion between fibers is small, and the space between each other can allow air and light to pass through. Therefore, when the air flows through the photocatalyst carrier structure, the chance of collision between the photocatalyst and the air can be greatly increased, and the surface area of the photocatalyst in contact with the light can also be increased, that is, the efficiency of the sterilization equipment can be increased.

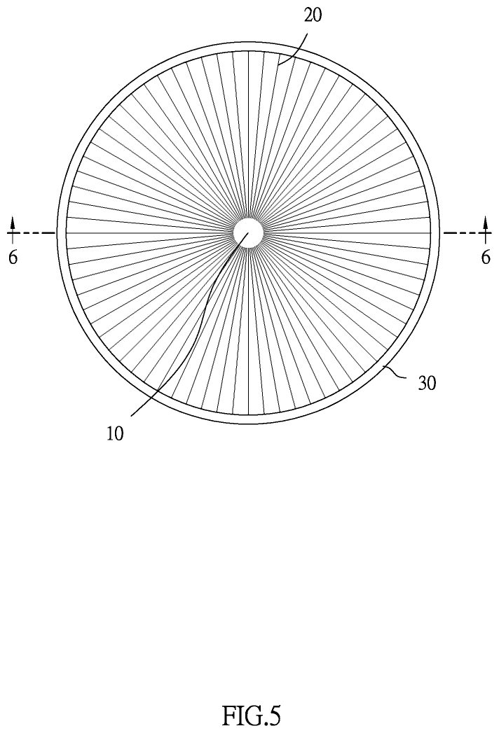

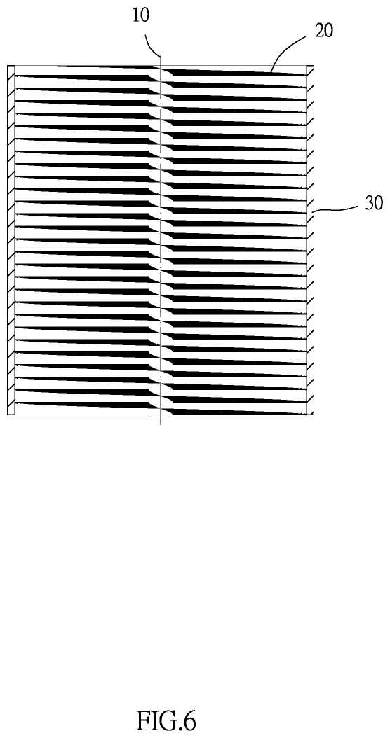

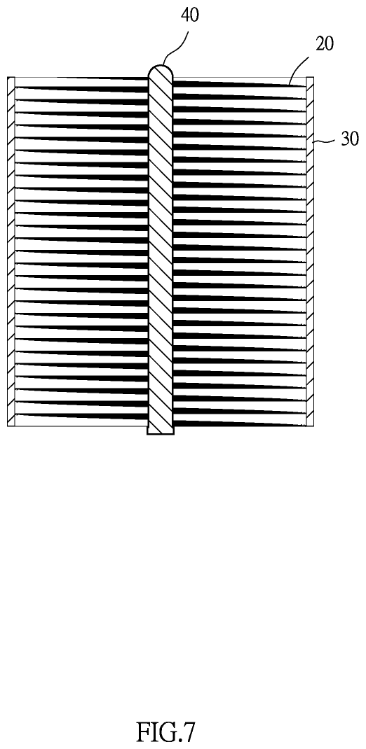

As shown in FIGS. 5-7, it is the second embodiment of the present invention. The catalyst carrier structure of the present invention comprises a ring wall 30 and a plurality of fibers 20.

The ring wall 30 takes an imaginary central axis as the central axis 10, and is set around the central axis 10.

The surface of each of the fibers 20 is coated with photocatalyst. The fibers 20 are centered on the central axis 10, and are arranged on the ring wall 30 in a radially inward radial direction along the axial direction of the central axis 10. These fibers 20 are an independent and separate fiber. These fibers 20 can be made of carbon fiber, glass fiber, or polyester. The diameter of each fiber is about 10 μm˜50 μm, and its length is 1˜200 mm.

The structure of the second embodiment of the present invention follows the same design concept of the present invention. These fibers 20 are also arranged around a central axis 10. But different from the first embodiment, in this embodiment, the central axis 10 is a virtual imaginary central axis, the fibers 20 are arranged on a ring wall 30 in a radial distribution from the outside to the inside, but the ring wall 30 is also arranged around the central axis 10 as the center. This structure can also make the fibers 20 three-dimensionally dispersed in one space, and a considerable gap can also be maintained between the fibers to increase the chance of the catalyst colliding with the air.

In the second embodiment of the present invention, if a photocatalyst is used, a light source 40 can be directly set at the position of the virtual central axis. In this way, the fibers 20 can be used to surround the light source 360 degrees, so that the light emitted by the light source 40 can be fully utilized in the reaction with the photocatalyst on the surface of the fibers 20 to improve the reaction efficiency of the sterilization equipment.

What is claimed is:

1. A catalyst carrier structure, comprising:
a central axis, which is a columnar structure; and
a plurality of fibers, each said fiber having the surface thereof coated with a catalyst, said fibers being centered on said central axis and arranged around said central axis radially outward along the axial direction of said central axis, said fibers being independent and separate fibers arranged on said central axis.

2. The catalyst carrier structure as claimed in claim 1, wherein the diameter of said fibers is 10 μm to 50 μm.

3. The catalyst carrier structure as claimed in claim 2, wherein the length of said fibers is 1˜200 mm.

4. The catalyst carrier structure as claimed in claim 3, wherein said fibers are selectively made of carbon fiber, glass fiber, or polyester.

5. A catalyst carrier structure, comprising:
a ring wall, with an imaginary axis as the central axis, set around said central axis; and
a plurality of fibers, each said fiber having the surface thereof coated with a catalyst, said fibers being centered on said central axis and arranged on said ring wall radially along the axial direction of said central axis.

6. The catalyst carrier structure as claimed in claim 5, wherein the diameter of said fibers is 10 μm to 50 μm.

7. The catalyst carrier structure as claimed in claim 6, wherein the length of said fibers is 1˜200 mm.

8. The catalyst carrier structure as claimed in claim 7, wherein said fibers are selectively made of carbon fiber, glass fiber, or polyester.
